(19) United States
(12) Patent Application Publication
(10) Pub. No.: US 2024/0395087 A1
(43) Pub. Date: Nov. 28, 2024

(54) METHOD AND SYSTEM FOR ACCESS TO A SECURED BUILDING AND A SECURED LOCKER SYSTEM

(71) Applicant: 1VALET CORP., Gatineau (CA)

(72) Inventor: Hanna HADDAD, Gatineau (CA)

(21) Appl. No.: 18/794,777

(22) Filed: Aug. 5, 2024

Related U.S. Application Data
(63) Continuation-in-part of application No. 17/530,395, filed on Nov. 18, 2021, now Pat. No. 12,056,974.
Application No. 17/530,395 is a continuation-in-part of application No. 17/041,945, filed on Sep. 25, 2020, now Pat. No. 11,443,580.
(60) Provisional application No. 62/852,605, filed on May 24, 2019.
(60) Provisional application No. 62/905,637, filed on Sep. 25, 2019.
(60) Provisional application No. 62/990,074, filed on Mar. 16, 2020.

(51) Int. Cl. G07C 9/00; G06Q 10/0833; G06Q 10/0835; G06Q 10/0836

(52) U.S. Cl. CPC G07C 9/00571; G06Q 10/0833; G06Q 10/08355; G06Q 10/0836; G07C 9/00896; G07C 2009/0092

(57) ABSTRACT

Embodiments of the present invention provide for a real-time method for tracking a vehicle or a delivery person in real-time using a location tracker and providing route planning with routes adjusted in real-time based on predefined metrics. The method further includes displaying this location relative to the recipient's address, and providing a real-time status that includes estimated and actual arrival times and delivery status (in transit, out for delivery, or waiting for pickup). There is further provided a method for tracking the productivity of the delivery person, including monitoring breaks and idle times. There is further provided a method for decentralized sorting of packages at sub-stations, performing initial and secondary sorting for specific destinations. Tracking information is stored in secure databases, accessible only by authorized entities, ensuring data security and confidentiality.

### CROSS-REFERENCE TO RELATED APPLICATIONS

The present application is a Continuation-in-Part of U.S. application Ser. No. 17/530,395, filed Nov. 18, 2021, which is a Continuation-in-Part of U.S. application Ser. No. 17/041,945, filed Sep. 25, 2020, which is a U.S. National Phase application under 35 U.S.C. 371 of International Application No. PCT/CA2020/050694, filed May 22, 2020, which claims priority to U.S. Application No. 62/852,605, filed May 24, 2019; U.S. Application No. 62/905,637, filed Sep. 25, 2019; and U.S. Application No. 62/990,074, filed Mar. 16, 2020. The foregoing applications are incorporated by reference herein in their entirety.

### FIELD OF THE DISCLOSURE

The present disclosure generally relates to the field of ensuring building security and providing secure delivery services including return services. In particular embodiments or aspects, the disclosure relates to methods and systems for accessing a secured building and a secured locker system located outside the secured building.

### BACKGROUND

Access to a secured building, for a non-tenant, generally require a tenant's presence at the building to permit access. Similarly, for service providers who may require access to a building, or a unit within the building, generally require a tenant's presence at the building and/or the unit to permit access. Service providers may include any party who requires access to the building and/or a unit within a building to provide a service. The service may be a plumbing service, and electrical service, a delivery of a package, mail, food, etc.

However, in particular for delivery services (e.g., package, mail, food, etc.), a delivery person may provide such services without accessing a secured building. For example, when the delivery person is unable to access the secured building, he/she may leave the package or parcel within a reasonable distance from the building, e.g., outside the lobby of the secured building. However, this may result in missing or stolen packages or parcels, and also personal information of the intended package recipients (e.g., resident's name, detailed address, contact number, purchase history, etc.) being improperly disclosed or misappropriated.

Furthermore, in order to return a package to the retailer, the recipient would generally need to contact the retailer (e.g., Amazon) and request for return of a package and/or a refund. The retailer would generally provide an electronic return label for the recipient to print out and attach to the package. Sometimes, the retailer would include a return label in the package for delivery in advance. Accordingly, the recipient may drop off the package with a return label at a designated drop off location (e.g., post office, a UPS facility, a FedEx facility etc.). Sometimes the recipient may need to pay for return shipping.

To summarize, a service provider attempting to access a building may be unable to provide its services if a tenant is not present to permit access, where required, or otherwise, the tenant is unable to permit access as required according to the building security protocols. Furthermore, a carrier or a delivery service provider attempting to provide delivery services without accessing a secured building may be unable to guarantee a satisfactory service standard or level that may be reasonably expected by the intended recipient, given the likelihood that a package or parcel being stolen or missing, or the possibility that the recipient's personal information may be obtained or misappropriated by unknown, unauthorized, random person, or the like. Additionally, the package recipients would expect to return unwanted packages in a simpler way to avoid running errands.

Accordingly, there is a need for a method and system that may be used to improve the access to a secured building for a service provider, allow a delivery service provider to securely provide delivery services without the need to access a secured building, and also allow a simpler way for a recipient to return a package to a retailer.

This background information is provided to reveal information believed by the applicant to be of possible relevance to the present invention. No admission is necessarily intended, nor should be construed, that any of the preceding information constitutes prior art against the present invention.

### SUMMARY

The present invention relates to a comprehensive system and method for improving package delivery and pickup processes through real-time tracking, route planning, and secure information storage. The system enables real-time tracking of both delivery vehicles and/or personnel, providing their current locations relative to the recipient's address and offering estimated and actual arrival times. This feature enhances transparency and efficiency, as both recipients and carrier companies can monitor the delivery progress. Additionally, the system supports one-way or two-way video communication via the application, facilitating real-time problem resolution at lower costs.

The invention may also include a real-time Global Positioning System (GPS) tracking system for delivery personnel, monitoring their productivity by recording the duration of breaks and idle times. This data helps assess employee efficiency, identify training needs, and categorize delivery areas based on demand volume. Critical path planning is another key aspect, with system-planned routes that adapt in real-time to factors such as traffic, weather, and parking availability. This ensures optimal route efficiency and time management. Furthermore, the system incorporates decentralized sorting at sub-stations, where preliminary sorting is conducted for larger areas, followed by secondary sorting and final delivery to individual mailboxes. Secure information storage is maintained at the building level or on a secured cloud, accessible only to authorized entities, with backups stored in an internal black box with limited access via secured code or protocols, such as virtual private network (VPN), ensuring data confidentiality and security.

In accordance with embodiments of the present invention, there is provided a real-time method of tracking a vehicle or a delivery person and providing route planning for delivery or pickup of a package associated with a recipient and an address of the recipient. The recipient's address can be within a multi-tenant building or portion thereof. The method includes tracking, by a location tracker, a location of the vehicle or the delivery person in real-time. The location tracker is associated with the vehicle or the delivery person. The method further includes displaying the real-time location of the vehicle or the delivery person relative to the recipient's address and providing a real-time status for the delivery or the pickup of the package. The status can include an estimated arrival time and an actual arrival time based on the real-time location of the vehicle or the delivery person relative to the recipient's address. The status further can include a delivery status indicating the package is one of: in transit, out for delivery, or waiting for pickup. The method further includes planning and displaying one or more routes for the delivery, or the pickup of the package based on predefined metrics. The predefined metrics can be updated in real-time. The method further includes updating the one or more routes in real-time based on the updated predefined metrics, and providing instructions to the delivery person, based on an automatic selection from the one or more planned routes and the updated predefined metrics. Furthermore, tracking information can be stored in one or more databases. The tracking information includes the real-time location of the vehicle or the delivery person for the delivery or the pickup of the package, the real-time location of the delivery vehicle or the delivery person relative to the recipient's address, the real-time status for the delivery or the pickup of the package, the planned one or more routes, and the selected route.

In embodiments, the method further incudes receiving, by an entry console of the building or portion thereof, a request for entry into the building or portion thereof. The request includes a tracking code associated with the package. The method further includes forwarding the tracking code to a building operating system (BOS) by the entry console and performing a verification procedure by the BOS based on the tracking code to determine if access to the building or portion thereof is to be permitted or denied. In embodiments, the method further includes providing, by the BOS, based on outcome of the verification procedure, instructions to the entry console regarding granting access into the building or portion thereof.

In embodiments, the verification procedure includes sending, by the BOS, a verification request comprising the tracking code to the one or more databases; comparing the tracking code in the verification request to the tracking information in the one or more databases and determining if access is permitted or denied based on the comparison. In embodiments, the tracking information in the one or more databases confirms that a delivery or pickup location of the package is in the building or portion thereof and the delivery status of the package is out for delivery or waiting for pick-up, thereby access is permitted.

In embodiments, the method further includes enabling a one-way or two-way video communication between the recipient and the delivery person in real-time.

In embodiments, the predefined metrics can include a capacity and a productivity of the delivery person being tracked in real-time, including a duration of breaks and idle times, an average time spent on each delivery or pickup, and a training or experience level of the delivery person; a type of the vehicle utilized; one or more alternative transportation options including walking; a priority level of the package; and a priority level of the building or a priority level of an area that the building belongs to. In embodiments, the priority level of the building is based on a volume level of package deliveries and pickups.

In accordance with an aspect of the present invention, there is provided a method for decentralized sorting of a plurality of packages using sub-stations. Each of the plurality of packages is associated with an address. The method performing an initial sorting of the plurality of packages, and each sub-station corresponds to a designated area. The sorted packages for the designated area are placed in a designated bag. For each designated bag, a subsequent sorting is performed, and the further sorted packages are delivered based on the associated address. The address can include a street or road name and number, or a postal code.

Embodiments have been described above in conjunctions with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended figures and drawings.

FIG. 1 is a block diagram of a built-in entry console within a computing and communications environment used for implementing devices and methods according to an embodiment of the present invention.

FIG. 2 is a call flow diagram of a package delivery procedure according to an embodiment of the present invention.

FIG. 3 shows a call flow diagram of the verification procedure discussed in FIG. 2 according to an embodiment of the present invention.

FIG. 4 shows another call flow diagram of the verification procedure discussed in FIG. 2 according to an embodiment of the present invention.

FIG. 5 shows a call flow diagram for depositing a package using the locker system, according to embodiments of the present invention.

FIG. 6 shows a call flow diagram of a package return procedure according to an embodiment of the present invention.

FIG. 7 shows a call flow diagram for integrating a mobile application with a retailer website according to an embodiment of the present invention.

FIG. 8 shows a schematic diagram of a computing device used as a mobile application controller according to an embodiment of the present invention.

FIG. 9 shows a flow chart for a real-time vehicle tracking and route planning method, according to an embodiment of the present invention.

FIG. 10 shows a flow chart for a decentralized sorting method, according to an embodiment of the present invention.

Throughout the appended drawings, like features are identified by like reference numerals.

### DETAILED DESCRIPTION

Embodiments described herein provide methods and systems for access to a secured building. Although example embodiments are described in reference to a service provider delivering a package, a person skilled in the art may apply the methods and systems as described by example embodiments herein for access to a building in the case of other service providers. Accordingly, delivery a package is but one example of a service provider, and thus example embodiments described herein are not limited to such example.

Every day, millions of packages or parcels are delivered throughout the world. In delivering the packages, service providers, for example, package delivery companies (“carriers”) use various tracking mechanisms to ensure efficient and effective delivery of the packages. When a sender delivers a package (sends a package for delivery), the carriers/service provider attach an information label including a unique code, such as a bar code (or barcode) to the package. The barcode contains information identifying the package, the sender, sender's address, the recipient, the recipient's address and other information relating to the status of the delivery (tracking information). The tracking information can be used by the carrier personnel, the sender, and/or recipient to determine the status of the delivery.

Despite the delivery mechanisms and the availability of the tracking information used by the carriers, not all packages are delivered to the recipients. One common reason for packages not being delivered to the recipient is because the recipient is not available to receive the package when the delivery person is at the recipient's address. In such circumstances, the carrier delivery person would attempt to deliver the package at a later time hoping that the recipient would be available to receive the package, or the delivery person would leave the package at a nearby carrier center for pick up by the recipient, or even leave the package at the recipient's address (e.g., outside the recipient's apartment, outside the lobby of the building) unattended.

For return of a package, the original recipient (e.g., a consumer, a building resident) now becomes the new sender, and original sender (e.g., retailer) now becomes the new recipient. To avoid the confusion and for better consistency in the following, the term “recipient” is used to refer to the consumer regardless whether it is for delivery of a package or return of a package, and the term “sender” is used to refer to the retailer regardless whether it is for delivery of a package or return of a package, wherever applicable.

If the recipient wants to return a received package, generally he or she would need to contact the retailer or sender (e.g., visiting the retailer's website and/or contacting the customer service personnel of the retailer by email, phone or online chat etc.) for a return label, which is usually in the electronic form. The recipient would then print out the return label and attached it to the package, and drop off the package for return at a designated location in accordance with the rules of any particular retailer. Sometimes, the package would contain a return label when initially received by the recipient. A return label is an information label including a unique code, such as a bar code (or barcode) to the package. The barcode contains information identifying the package, the sender/retailer, sender/retailer's address, the recipient/consumer, the recipient/consumer's address and other information relating to the status of the delivery (tracking information). The tracking information can be used by the carrier personnel, delivery personnel, the sender/retailer, and/or recipient/consumer to determine the status of the delivery.

Alternatively, the retailer may arrange for a carrier or a delivery person to pick up the return package directly from the recipient or at the recipient's address. This may require a tenant's presence or a resident's presence at the building or at a designated place to permit access to a secured building or a secured locker system (which may be referred to as a parcel return station).

Similar problems are also likely for other service providers who require access to the building, such as an electrician, a plumber, a food delivery person, etc.

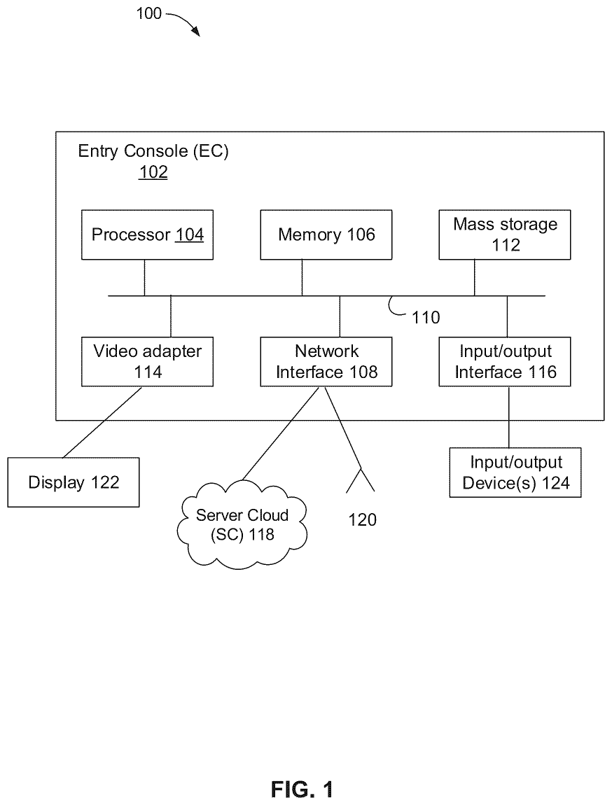

FIG. 1 is a block diagram of a built-in entry console (EC) 102 within a computing and communications environment 100 used for implementing the devices and methods disclosed herein. In some embodiments, the EC 102 is a device that connects to network infrastructure over a radio interface. In some embodiments, EC 102 is a Machine Type Communications (MTC) device (also referred to as a machine-to-machine (m2m) communication device). The EC 102 device may contain multiple instances of a component, such as multiple processors, memories, transmitters, receivers, etc. The EC 102 typically includes a processor 106, such as a Central Processing Unit (CPU), I/O interface 116 to connect with I/O devices (such as a barcode scanner and an access door), a memory 106, a network interface 108 and a bus 110 to connect the components of EC 102. EC 102 may optionally also include components such as a mass storage device 112, a video adapter 114 (shown in dashed lines).

The memory 106 may comprise any type of non-transitory system memory, readable by the processor 106. The bus 110 may be one or more of any type of several bus architectures including a memory bus or memory controller, a peripheral bus, or a video bus.

The one or more network interfaces 108, may include at least one of a wired network interface and a wireless network interface. The EC 102 can connect wirelessly to the console's cloud server 118 via network interface(s) 108 for sending and receiving information. The EC 102 can also include a radio access network interface 120 for connecting to other devices over a radio link.

The mass storage 112 may comprise any type of non-transitory storage device configured to store data, programs, and other information and to make the data, programs, and other information accessible via the bus 110. In the illustrated embodiment, mass storage 112 is distinct from memory 106 where it is included, and may generally perform storage tasks compatible with higher latency, but may generally provide lesser or no volatility. In some embodiments, mass storage 112 may be integrated with a memory 106 to form a heterogeneous memory.

The I/O interface 116 is connected to I/O device(s) 124 such as a barcode scanner capable of reading a barcode attached to packages for delivery. The EC 102 is also connected to an access door used by a delivery person in delivering packages. The EC 102 can grant access to a delivery person to deliver a package to a recipient or pick up a package returned by a recipient where a package passes the verification procedure described elsewhere herein. The EC 102 grants access by opening a door permitting the delivery person to deposit or pick up the package.

The EC 102 can also be coupled to a touch-screen I/O device 124 for permitting the delivery person to manually input information into the EC 102. The optional video adapter 114 (shown in dashed lines) provides interfaces to couple the EC 102 to a display for providing information to the delivery person.

In some embodiments, EC 102 is a built-in standalone device that can be installed in any property used for receiving one or more delivery packages. Such properties include any multi-unit/tenant property.

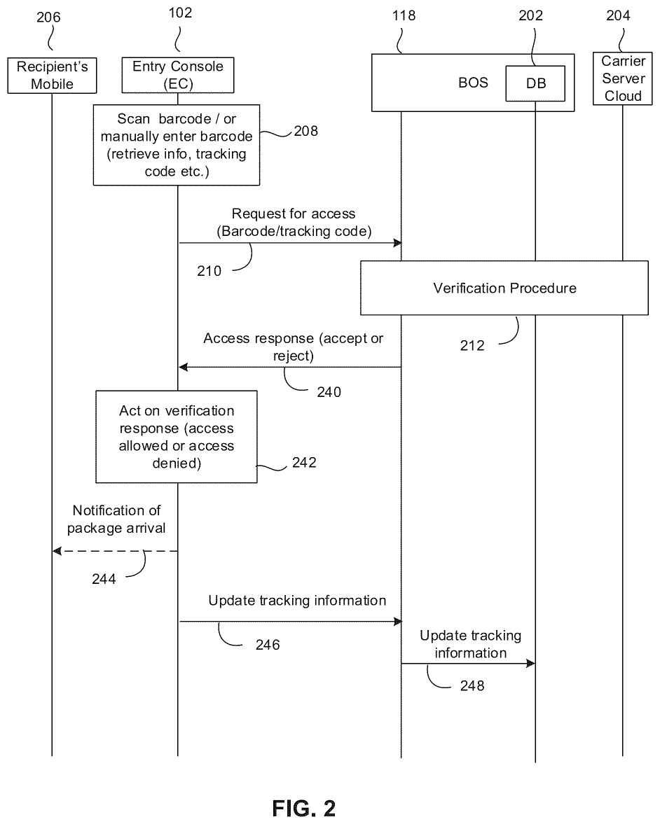

FIG. 2 is a call flow diagram of a package delivery procedure according to an embodiment of the present invention. In an embodiment, the package delivery procedure begins with a delivery person having arrived at the package delivery destination, the recipient's address, which would be indicated on the information label attached to the package. In another embodiment, for return of a package, the package return procedure begins with a delivery person having arrived at the package return starting point, the recipient's address, which would be notified to the carrier/delivery person by the retailer in advance. The recipient's address may also be indicated on the information label or return label attached to the package which is dropped into the designated locker/mail box. In some embodiments, the retailer may provide an information label or return label in the electronic form to the carrier/delivery person, via an email, a text message, a mobile application message, etc. For delivery of a package, at step 208, the delivery person, using the barcode scanner device 124, scans the unique barcode included as part of the information label attached to the package. Alternatively, the delivery personnel can manually enter the barcode number disclosed on the information label using the touch screen of the EC 102. For return of a package, at step 208, the delivery person, using the barcode scanner device 124, scans the unique barcode included as part of the information label provided by the retailer. Alternatively, the delivery personnel can manually enter the barcode number disclosed on the information label provided by the retailer, using the touch screen of the EC 102.

A code may be any form of information that a service provider may use to access a secured building. In the case of package delivery, a code may be a barcode.

A barcode is an encoded image (representation of data), usually displayed with black and white lines, but also in other variations, in various patterns that contains information that is readable by a machine. Barcodes may take various forms including non-specific 1 dimensional (1D) linear barcodes, 2-dimensional (2D) matrix barcodes, specialized augmented postal codes such as Postal Alpha Numeric Encoding Technique (PLANET), Postal Numeric Encoding Technique (POSTNET), Intelligent Mail barcodes, and other electronic product codes (EPC-s).

A code, for example, a barcode, includes various information, for example, a tracking code from which the following information can be determined: carrier type (the package delivery company), the sender information containing the sender's address, the recipient information containing the recipient's address, and other relevant information (packaging information). Further, the tracking code is associated with tracking information that is updated at the various stages of the delivery. The tracking information can be obtained via the tracking code to inform the sender and/or the recipient of the status of the delivery. All such information is stored and updated in a database (DB) 202 accessible by the EC 102.

Tracking information is gathered at various stages of the package delivery and maintained in the DB 202. Tracking information may be gathered by reporting the arrival and/or departure of the package at the various stages of the packing delivery. At each stage, information including the identity of the package, the location, the time, and the status of the delivery, for example, “waiting for pick-up”, “in-transit” and “out for deliver” can be uploaded and updated to the DB 202. Alternatively, tracking information may be gathered using Global Positioning System (GPS)-based vehicle tracking system, and/or beacons to locate the delivery vehicle that contains the package and record the tracking information in a real-time to DB 202. Additional information related to the package may also be gathered, for example package information relating to the temperature, humidity, pressure, acceleration, elevation, and exposure to light at different time points, which may be relevant for delicate or perishable packages.

The package information including the tracking information is maintained in a DB 202, which can be but need not be internal to the server cloud (SC) 118. The DB 202 may also within a carrier's server cloud (CSC) 204 accessible by the console's BOS 118. Alternatively, the BOS 118 may use both an internal DB 202 and an external database. The external data base may be within the CSC 204 or a separate entity, in which the external entity/DB may be accessed by both the console's BOS 118 and the CSC 204.

The delivery personal can use the barcode scanner 124 to scan 208 the barcode. Alternatively, the delivery personnel can manually enter the barcode number disclosed on the information label using the touch screen I/O device 124. The delivery personnel may manually enter the barcode number in situations where the barcode scanner is unable to read the barcode for whatever reason.

The EC 102 retrieves information 208 embedded in the scanned barcode, for example, a tracking code, from which the following information can be determined: carrier type (the package delivery company), the sender information containing the sender's address, the recipient information containing the recipient's address, and other relevant information (packaging information). Further, the tracking code is associated with tracking information that is updated at the various stages of the delivery. The tracking information can be obtained via the tracking code to inform the sender and/or the recipient of the status of the delivery.

The EC forwards 210 the retrieved information to the Building Operating System (BOS) 118. Using the retrieved information, the BOS 118 and CSC 204 perform a verification procedure 212 to ensure that the package is indeed a legitimate package addressed to the recipient in case of delivery of a package, or indeed a legitimate package returned by the recipient in case of return of a package. Following the verification procedure 212, the BOS 118 provides a response 240 instructing the EC 102 to permit or deny entry to a door associated with the recipient's address provided in the packaging information. The door associated with the recipient's address provided in the packaging information may be a door for providing access to a locker system for depositing the package to a locker associated with the recipient or for picking up the package from a locker associated with the recipient. The response may be a positive response, allowing the delivery person access via instructing the EC 102 to open the door, or a negative response, denying access to the door.

The EC 102 will then act on the response 242 from the BOS 118. If the response 240 is a positive response, for example, “access allowed”, the EC 102 will open the door associated with the recipient's address for the delivery person to access the locker system for depositing the package or picking up the package. The EC 102 may display an access code that may be used at the locker system to access the recipient's locker/mailbox.

In some embodiments, for delivery of a package, where the response is positive, the EC 102 sends a message 246 to the BOS 118 indicating that the package has been delivered, and accordingly, the BOS 118 will update the tracking information in the DB 202 via a similar message 248 indicating that the package associated with the scanned barcode has been delivered to its destination. In some embodiments, for return of a package, where the response is positive, the EC 102 sends a message 246 to the BOS 118 indicating that the package has been picked up, and accordingly, the BOS 118 will update the tracking information in the DB 202 via a similar message 248 indicating that the package associated with the scanned barcode has been picked up.

In some embodiments, where the response 240 is a positive response, the EC 102 notifies 244 the recipient's mobile (RM) 206 via a message that a package addressed to the recipient has been received for delivery of a package or a message that a package returned by the recipient has been picked up for return of a package. The recipient may receive the message via various means including but not limited to email, voice message, text, and/or alert and other means of notifications/messaging.

If the response 240 is a negative response, for example “access denied”, the EC 102 will not open the door. In some embodiments, the EC 102 may display a message on the display 122 for the delivery person that the access is denied. The EC 102 may include the reason for denying access, which could be one or more of the following: the carrier is not a recognized carrier; package is not “in transit” or “out for delivery” for delivery of a package; package is not “waiting for pick-up” for return of a package; and last update status is not within the past 24 hours. The reason for denying access can be provided in the response 240 provided by the SC 102. The reason for denying access may be useful to the delivery person in verifying the package at the delivery person's carrier center where more information about the package can be obtained.

In some embodiments, where the response 240 is a positive response, the EC 102 may notify the recipient's mobile (RM) 206 via a message that a package addressed to the recipient is expected to be received for delivery of a package or a message that a package returned by the recipient is expected to be picked up for return of a package. The recipient may receive the message via various means including but not limited to email, voice message, text, app notification and/or alert and other means of notifications/messaging.

Where access has been granted at step 242, the EC 102 may send a message 246 to the BOS 118 indicating that the package is expected to be deposited or expected to be picked up. Accordingly, the BOS 118 will update the tacking information in the DB 202 via a similar message 248 indicating that the package associated with the scanned barcode is expected to be deposited at the recipient's assigned locker for delivery of a package or expected to be picked up at the recipient's assigned locker for return of a package.

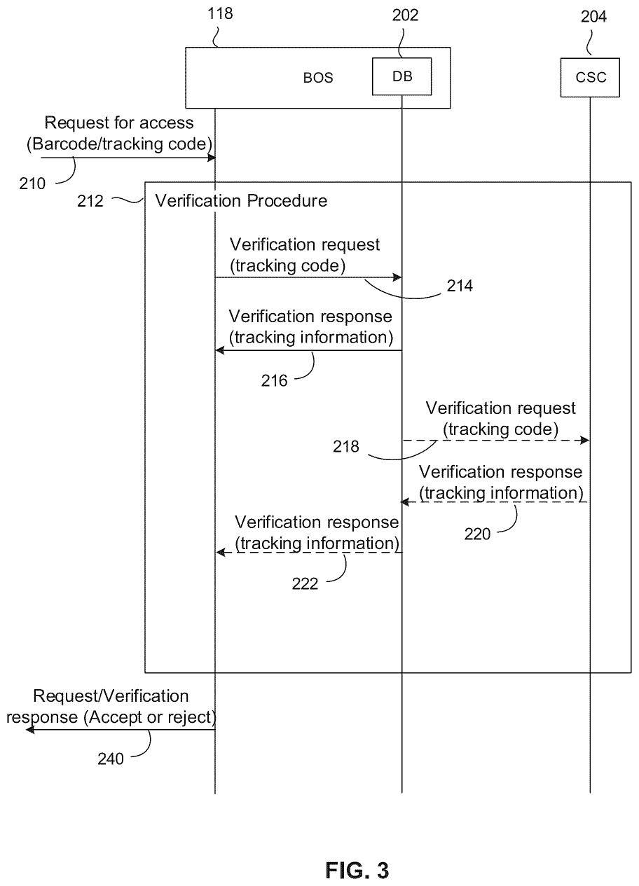

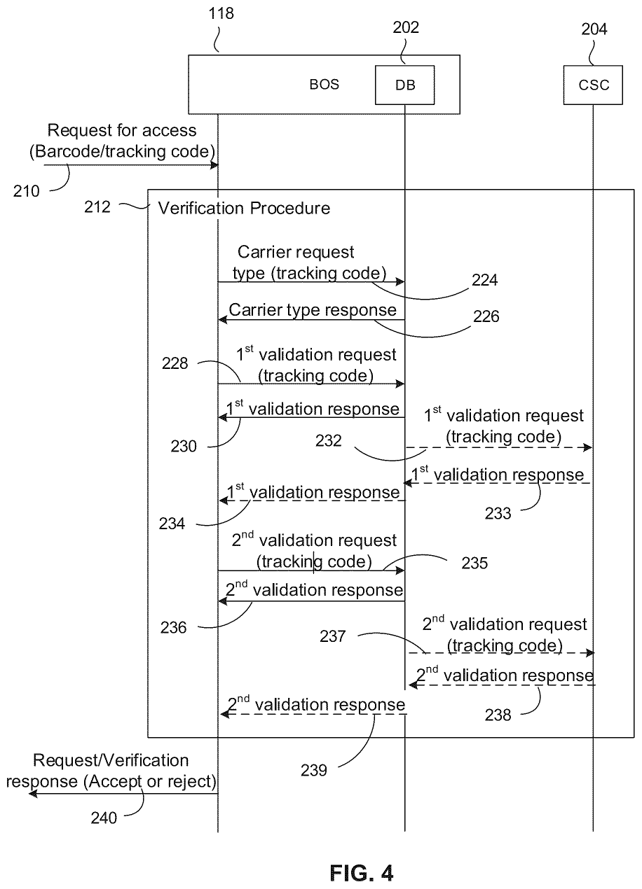

FIG. 3 and FIG. 4 are call flow diagrams of the verification procedure 212 discussed in FIG. 2 according to embodiments of the present invention.

Referring to FIG. 3, when the BOS 118 receives the retrieved information including the unique tracking code 210, the BOS 118 sends a verification request 214 including the retrieved information to its local DB 202. The request 214 requests the following information: the carrier type associated with the tracking code; whether the package associated with the tracking code has a delivery status of either “in transit” or “out for delivery” for delivery of a package; whether the package associated with the tracking code has a delivery status of “waiting for pick-up” for return of a package; and whether the last delivery status update associated with the tracking code is within the last 24 hours. The local DB 202 includes a list of recognized/registered carrier types including but not limited to, United Parcel Service (UPS), FedEx, Dalsey Hillblom Lynn (DHL), Canada Post, Purolator and Intelcom Express. For each carrier type, the local DB 202 may receive updates from the CSC 204 on the status of package deliveries destined for the building or picked up from the building.

At step 216, If the DB 202 has been updated by the CSC 204 with the status of the package delivery requested information, the DB 202 responds by providing a verification response providing tracking information 216 associated with the tracking code to the BOS 118.

Where the DB 202 determines that the carrier type of the tracking code is a registered carrier type with BOS 118 but is unable to determine whether the delivery status of the package is either “in transit” or “out for delivery” for delivery of a package or whether the delivery status of the package is “waiting for pick-up” for return of a package, the DB 202 may forward a request 218 to the carrier's server cloud 204 of the determined carrier. Where the DB 202 determines the carrier type of the tracking code but is unable to determine whether the last delivery status update of the package associated with the tracking code is within the last 24 hours, the DB 202 may also forward the request 218 to the server cloud 204 of the determined carrier.

In some embodiments (not shown), the BOS 118 may forward the request 218 to the CSC 204, instead of the DB 202 sending the request 218 to the CSC 204. Upon receiving the request 218, the CSC 204 can search its internal network, including the GBS-based vehicles to locate the delivery vehicle that contains the package and record the tracking information 220 in real-time to DB 202.

Accordingly, the DB 202 provides the updated tracking information 222 to BOS 118.

The BOS 118 sends a response 240 instructing the EC 102 whether to permit or deny access to the delivery person. The BOS 118 permits access only if the following information (required information) is provided in the verification response 216 or 222: the carrier type is recognized; the delivery status associated with the tracking code is either “in transit” or “out for delivery” for delivery of a package; the delivery status associated with the tracking code is “waiting for pick-up” for return of a package; and the last delivery status is updated within the last 24 hours. If any of the required information is not provided in the responses 216 and/or 222, the response 240 is a negative response, denying access to the delivery person.

FIG. 4 is alternative call flow diagram of the verification procedure 212 discussed in FIG. 2 according to embodiments of the present invention.

Referring to FIG. 4, upon receiving the request for access 210, the BOS 118 may alternatively send individual requests 224, 228, 235 to its local DB 202 for the required information in verifying the package as part of the verification procedure 212. The BOS 118 sends a carrier request 224 to the DB 202, including in the request the retrieved tracking code.

If the DB 202 recognizes the carrier type as a registered carrier type with BOS 118, then the DB 202 responds positively with the name of carrier type. Otherwise, the DB may provide a negative respond. The negative response can be a no response, or a message to the BOS 118 that the DB does not recognize the carrier type of the tracking code. If the BOS 118 receives a negative response for carrier type, the BOS 118 accordingly sends a negative response at step 240 denying access to the delivery person.

Where the BOS 118 receives a carrier type response 226 recognizing the carrier type of the tracing code, BOS 118 sends a first validation request 228 to DB 202 requesting whether the delivery status associated with the tracking code is either “in transit” or “out for delivery” for delivery of a package, or whether the delivery status associated with the tracking code is “waiting for pick-up” for return of a package.

The DB 202 may respond that the delivery status is either “in transit” or “out for delivery” for delivery of a package or that the delivery status is “waiting for pick-up” for return of a package, provided DB 202 has been updated by the CSC 204. The DB 202 may provide a negative response to the request 228; the negative response may be that DB has no information on the delivery status or a current delivery status other than “in transit” and “out for delivery” is associated with the tracking code for delivery of a package, or a current delivery status other than “waiting for pick-up” is associated with the tracking code for return of a package.

Where the DB 202 provides a negative response, the DB 202 may forward the first validation request 232 to the server cloud 204 of the recognized carrier type.

The CSC 204 can search its own network, including the GBS-based vehicles to locate the delivery vehicle that contains the package and record the tracking information 233 in real-time to DB 202. The tracking information 233 may include an update to the delivery status indicating “in transit” or “out for delivery” for delivery of a package or an update to the delivery status indicating “waiting for pick-up” for return of a package; and accordingly, the DB 202 forwards the tracking information 234 to BOS 118.

If the response 234 is a negative response, meaning that the response does not include a delivery status that is one of “in transit” or “out for delivery” for delivery of a package or that the response does not include a delivery status that is “waiting for pick-up” for return of a package, then the BOS 118 sends a negative response at step 240 the EC 102 denying access to the delivery person.

If the validation response 232 or 234 is a positive response indicating that the delivery status associated with the tracking code is one of “in transit” or “out for delivery” for delivery of a package or that the delivery status associated with the tracking code is “waiting for pick-up” for return of a package, then the BOS 118 sends a second validation request 235, requesting the DB 202 if the last update status associated with the tracking code was within the last 24 hours.

It should be noted that BOS 118 can request the first 228 and second 235 validation requests in any order; and in some embodiments the BOS 118 may only ask for one validation request including both the first and second validation requests in one request.

The DB 202 may provide a positive or a negative response 236 to the BOS 118. The positive response being that the last update status is within the last 24 hours and the negative response is that the last update status is not within the last 24 hours. If the DB 202 was last updated by the CSC 204, then the response 236 is a positive response, otherwise response 236 is a negative response.

Where the DB 202 provides a positive response 236 to BOS 118, having also provided a positive response for carrier type 226 recognizing a carrier type and a positive response 230 for the first validation request 228, then the BOS 118 sends a positive verification response 240 to the EC 102 allowing access to the delivery person.

Where the DB provides a negative response 236, the DB may forward the request 237 for the second validation request to the carrier's server cloud 204 of the recognized carrier. The CSC 204 can search its own network, including the GBS-based vehicles to locate the delivery vehicle that contains the package and record the tracking information 233 in real-time to DB 202. The tracking information 238 may include an update to the delivery status; and accordingly, the DB 202 forwards the tracking information 239 to BOS 118, indicating a status update within the last 24 hours.

If the response 239 is a negative response, meaning that the response indicates a last update status beyond the last 24 hours, the BOS 118 sends a negative response 240 the EC 102 denying access to the delivery person.

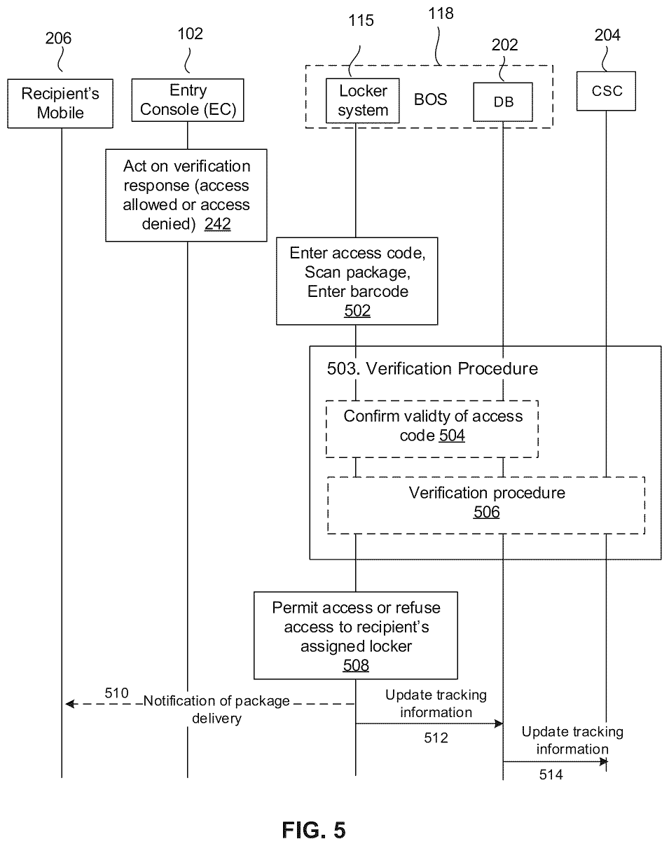

FIG. 5 illustrates a call flow diagram for depositing a package using the locker system, according to embodiments of the present invention.

As discussed in step 242 of FIG. 1, where the response is a positive response, the EC 102 will permit the delivery person to have access to the locker system 115 for depositing the package at the recipient's assigned locker/mail box for delivery of a package or picking up the package at the recipient's assigned locker/mail box for return of a package.

Referring to FIG. 5, the locker system 115 includes a plurality of locker/mail boxes, each assigned to a registered tenant/recipient of the building, as determined by the BOS 118. The locker system 115 may be separate from or part of the BOS 118, but must be able to communicate with the BOS 118.

Where the delivery person has been permitted access to the locker system at step 242, the delivery person may proceed to depositing the package for delivery of a package, or picking up the package for return of a package.

At step 502, the delivery person may enter the access code that was displayed on the EC's display 122 at step 242. Alternatively, the delivery person, using the barcode scanner of the locker system 115, may scan the package's bar code, or the barcode included as part of the information label, or manually enter the barcode.

The access code may have a limited validation window during which the delivery person must use to deposit the package at the locker system.

At steps 503 and 504, where the access code is used to access the recipient's locker, the locker system may confirm validity of the access code. The locker system 115 confirms the validity of the access code by confirming that the time window has not expired, and further confirming that the access code is associated with a recorded verification response in the local DB 202 and message at step 246 and/or 248 that the package is expected to be deposited or picked up at the locker system 118. In some embodiments, the delivery person may fail to complete the required steps or operations before the time window expires, due to multiple packages, a bulky package, a package requiring special handling or other factors. In such circumstances, the delivery person may be allowed to re-open the time window, continue with the unfinished steps or operations, or start over. In some embodiments, the delivery person may have the option to choose the appropriate time window, for example, a longer time window or consecutive time windows for multiple packages, a bulky package, a package that requires special handling, or the like. In some embodiments, the delivery person may be allowed to contact the recipient/consumer, the sender/retailer, the security personnel of the building, the carrier personnel, or the like for further assistance.

At steps 503 and 506, where the validation window for the access code has expired, or the delivery person has decided to scan or manually input the bar code to access the recipient's locker, then the locker system 115 along with the local DB 202 and the CSC 204 performs the verification procedure as described with reference to step 212 of FIG. 2, and further described in FIG. 3 and FIG. 4.

At step 508, If the verification procedure at step 503 results in a confirmation of the validity of access code at step 504 or a positive response to the verification procedure at step 506, then the locker system will permit access to the recipient's locker.

If at step 504 the access code determined not be valid, then the locker system will deny access to the recipient's locker and display a message. The message may indicate that the delivery person should attempt to deposit the package or pick up the package using the barcode. Further the message may indicate that the validation window has expired. In some embodiments, the message may further indicate other options such as re-opening the validation time window, contacting the recipient/consumer, the sender/retailer, the security personnel of the building, the carrier personnel, or the like, and etc. The message may also indicate that the access code is not associated with a verified response (referring to the response at step 240 of FIGS. 2, 3 and 4.

If the verification procedure 506 results in a negative response, then the locker system 115 will refuse access to the recipient's locker and display a message. The message may indicate the reason for the negative response as was discussed above, and reproduced here for convenience. The reason for refusing access may be one or more of the following: unregistered recipient; the carrier is not a registered carrier; package is not “in transit” or “out for delivery” for delivery of a package; package is not “waiting for pick-up” for return of a package; and last update status is not within the past 24 hours.

At step 510, where the delivery person is permitted access to the recipient's assigned locker at step 508, the locker system 115 may notify the recipient's mobile (RM) 206 via a message that a package addressed to the recipient has been received or that a package returned by the recipient has been picked up. The recipient may receive the message via various means including but not limited to email, voice message, text, app notification and/or alert and other means of notifications/messaging.

At step 512 and 514, where access has been granted at step 508, the locker system 115 will update the tacking information in the DB 202 via a message indicating that the package associated with the scanned barcode has been deposited at the recipient's assigned locker or that the package associated with the scanned barcode has been picked up at the recipient's assigned locker.

At step 514, the local DB 202 will then notify the CSC 204 that the package has been received at the recipient's address or that the package has been picked up at the recipient's address.

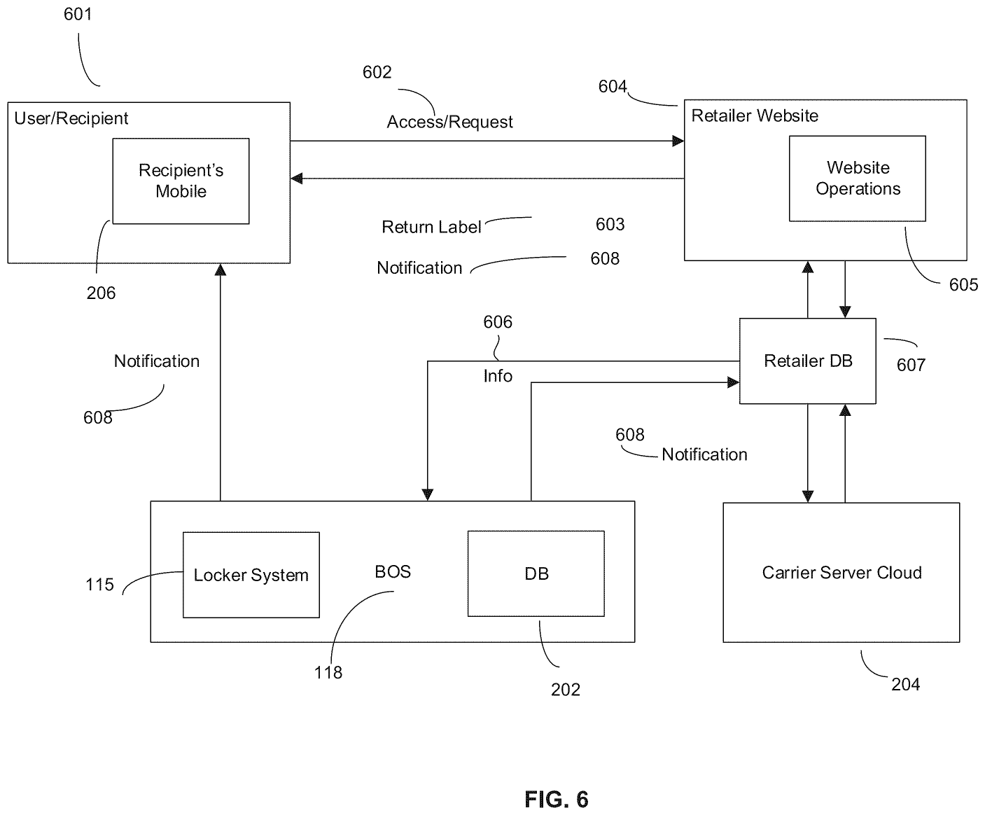

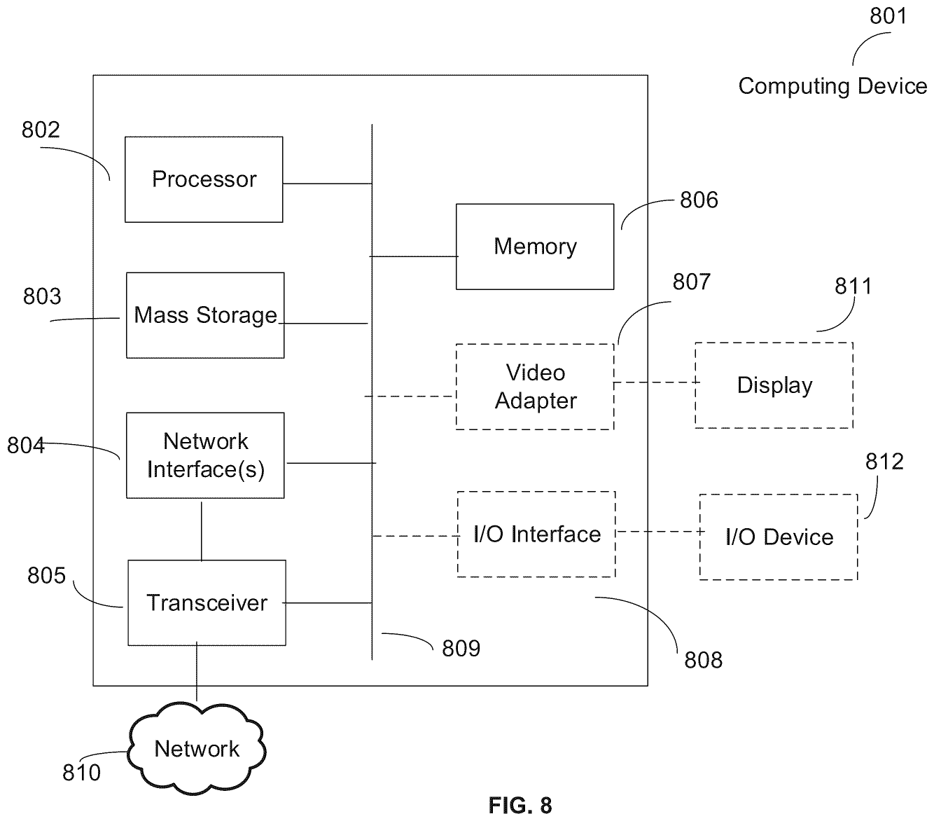

FIG. 6 illustrates a package return procedure according to an embodiment of the present invention. In some embodiments, a recipient or a user 601 wishing to return a package may access 602 the retailer's website 604 (e.g., Amazon's website) and obtain a return label 603. The access or request of user 601 may be sent from the recipient's mobile 206 or any other electronic or computing device 801 (e.g., illustrated in FIG. 8). In some embodiments, a return label may be prepared and included in the package in advance by the retailer. The retailer website 604 may provide a series of website operations 605 relating to a package or a placed purchase order. For example, on the retailer's website 604, the recipient may select the package drop-off site as a locker system including a locker/mail box in a secured building or a secured locker system including a locker/mail box outside the building. The selection of package drop-off site or pick-up location or any other information obtained on the website will be synchronized into a retailer database (i.e., retailer DB 607). The information 606 including drop-off site selection will be communicated from the retailer DB 607 to the BOS 118 and/or DB 202. Similarly, the same information 606 will be communicated from the retailer DB 607 to carrier server cloud 204. The recipient may scan the return label 603 at the locker system 115 (e.g., entry console 102), then an assigned locker/mail box will open automatically. If there is one or more access doors associated with the locker/mail box, the access door(s) will also open automatically. Once the package is deposited or dropped off at the assigned locker/mail box and the locker/mail box is closed, a notification 608 will be sent to the retailer (e.g., Amazon) DB 607 indicating that the return package is in the assigned locker/mail box, ready to be picked up. Accordingly, a notification 608 will also be sent to a delivery person for pick up. The notification for package pick-up sent to the delivery person may include a code or barcode that may be used on the entry console. The delivery person may scan the code at the locker system (e.g., entry console) and be allowed to enter a secure building or a secured locker system for package pick-up in accordance with the aforementioned procedures (e.g., illustrated by FIG. 2 to FIG. 5). In some embodiments, an update notification 608 from the BOS 118 could be sent to resident that the package has been picked up. An update notification 608 from the retailer DB 607 could also be sent to resident that the package has been picked up.

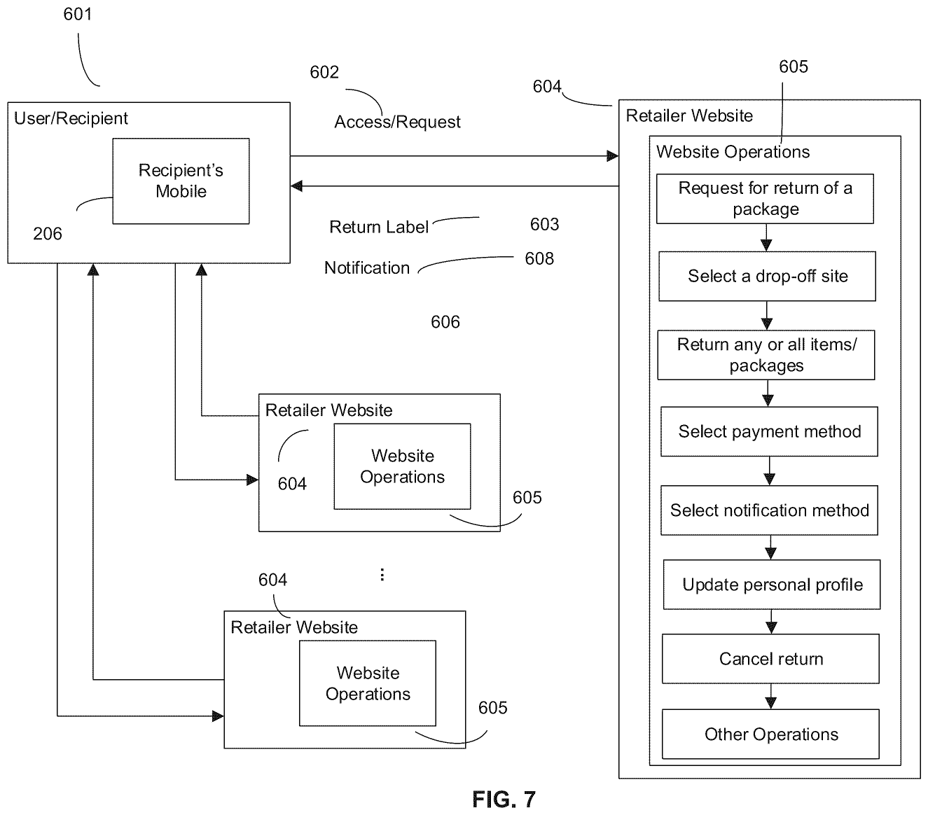

FIG. 7 illustrates the integration of a mobile application with a retailer website according to an embodiment of the present invention. In some embodiments, the mobile application is configured to be a gateway to one or more of the retailer websites 604. Generally, the mobile application is operated or controlled by a computing device (e.g., a computer or a mobile phone).

For example, the recipient may request for return of a package through the mobile application by performing one or more of the following operations (i.e. website operations 605): the recipient may select a package drop-off site as a locker system including a locker/mail box in a secured building or a secured locker system including a locker/mail box outside the building; the recipient may select to return any or all of the packages received or any or all items of a particular package in accordance with the return policy of a specific retailer; the recipient may select the payment method and proceed to payment if a return shipping fee is required in accordance with the return policy of a specific retailer; the recipient may select the message notification method (e.g., email, text message etc.); the recipient may update his or her personal profile including contact phone number, email address and etc. In some embodiments, the recipient may receive a return label (e.g., in the form of a code or a barcode) via the mobile application, or via text message or email etc. In some embodiments, the recipient may cancel the return of a package via the mobile application if he/she changes his/her mind before the package is picked up by the delivery person. In some embodiments, any or all of the website operations may be performed in any feasible sequence.

FIG. 8 is a schematic diagram of a computing device 801 that may be used as a mobile application controller. A controller may perform any or all of mobile application operations explicitly or implicitly described above, according to different embodiments of the present invention. For example, a computer or a mobile phone equipped with network function may be configured as a computing device 801. In some embodiments, the computing device may be coupled to the Building Operating System (BOS) wherein the computing device is configured to send a message to or receive a message from the BOS.

As illustrated in FIG. 8, the computing device 801 includes a processor 802, such as a central processing unit (CPU) or specialized processors such as a graphics processing unit (GPU) or other such processor unit, memory 806, non-transitory mass storage 803, I/O interface 808, network interface 804, video adaptor 807, and a transceiver 805, all of which are communicatively coupled via bi-directional bus 809. Video adapter 807 may be connected to one or more of display 811 and I/O interface 808 may be connected to one or more of I/O devices 812 which may be used to implement a user interface. According to embodiments, any or all of the depicted elements may be utilized, or only a subset of the elements. Further, the computing device 801 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 806 may include any type of non-transitory memory such as static random access memory (SRAM), dynamic random access memory (DRAM), synchronous DRAM (SDRAM), read-only memory (ROM), any combination of such, or the like. The mass storage element 803 may include any type of non-transitory storage device, such as a solid state drive, hard disk drive, a magnetic disk drive, an optical disk drive, USB drive, or any computer program product configured to store data and machine executable program code. According to embodiments, the memory 806 or mass storage 803 may have recorded thereon statements and instructions executable by the processor 802 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations, or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, software-related operations of the method may be executed on any computing device, such as a personal computer, server, PDA, or the like and pursuant to one or more, or a part of one or more, program elements, modules or objects generated from any programming language, such as C++, Java, Python, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Furthermore, additional security and management functions may be provided to the building residents by installing without limitation one or more of the following widgets or accessories in a secured building or in a secured locker system: a motion detector, a body heat sensor, a camera with a face recognition element and/or a voice recognition element, a display screen, etc. or a combination thereof.

In some embodiments, the widgets or accessories may be separate from or part of the BOS 118 but must be able to communicate with the BOS 118.

In some embodiments, one or more of motion detectors are deployed to perform a motion detection function, in order to enhance the safety and security of the building's residents and properties, etc. As an important component of any security system, the motion detectors may use sensors to detect a change in the position of an object or a person relative to the surroundings or a change in the surroundings relative to an object or a person. As a baseline, a list of authorized activities may include a motion trajectory of moving from a building entrance across the lobby to the elevator, or a motion trajectory of engaging with an Entry Console (EC) 102 for a reasonable period of time and then proceeding to the locker/mail boxes, or temporarily pausing in front of a display screen, etc. The motion detection function may be used to detect any suspicious, dangerous, unauthorized activities in real time (e.g., suspiciously lingering at a certain spot, repetitive violent behaviors, fire hazards), and it may further include promptly sending alert messages to the BOS, security personnel of the building, and/or the building's residents. In some embodiments, the BOS may be configured to automatically take further actions (e.g., call the police, contact the city's fire department, etc.). In some embodiments, different parameters (delays, thresholds, etc.) of the motion detectors may be changed, and the database of authorized activities and/or unauthorized activities may also be updated in real time.

In some embodiments, one or more of body heat sensors are deployed within the building or even outside the building to perform a body temperature checking function. The body temperature checking function includes monitoring the body temperature of a person entering and exiting an entrance, an exit or a designated area (e.g., before the elevator, before the access door of the locker system, etc.). In some embodiments wherein the body heat sensors may be coupled with the display screens, the body temperature checking function may include displaying the body temperature being measured, with or without a message indicating “normal human temperature”, “above normal human temperature”, etc. In some embodiments, the body temperature checking function may include sending alert messages. For example, during the COVID-19 pandemic, the body heat sensors may be configured to notify the BOS 118 promptly if one or more persons (e.g., delivery person, service provider, resident etc.) are detected with abnormal body temperature, and the BOS 118 may further send alert messages to security personnel of the building, intended package recipient and/or other building residents, carrier personnel, or the like. The delivery person having an abnormal body temperature may be further denied access to the secured building, the secured locker system or an access door as part of the COVID-19 preventive measures. In some embodiments, the person having abnormal body temperature may be asked to verify his or her identify (e.g., name, address, etc.) via the EC 102 (e.g., a touch-screen I/O device 124) or a face recognition or voice recognition widget if applicable. For example, the identity of the person may be automatically recognized or verified by comparing his or her face or voice with the information stored in the DB 202, or the like.

In some embodiments, one or more of cameras (e.g., improved 3D cameras) are deployed to perform a human recognition function. The camera is able to capture the depth and points of a person's face contour to support face recognition and it may also be configured to support voice recognition. Such software and/or hardware widgets are capable of identifying or verifying a person through an image, video, or any audiovisual element of the person. Accordingly, a matching analysis may be triggered to determine the similarity between this person's face and/or voice with a database storing biometrics profiles. For example, the matching analysis may be conducted via the BOS 118, and the biometrics profiles (including faces, voices etc.) of an authorized person (e.g., a building resident, a security personnel, a delivery person) may be stored in DB 202. The BOS 118 may be further configured to access public/online/remote database storing biometrics profiles (e.g., criminal suspects wanted by the RCMP). In some embodiments, the human recognition function may be deployed simultaneously with the motion detection function. For example, an alert message may be sent to the security personnel of the building if the BOS 118 determines that an unauthorized person is engaging an unauthorized activity within or near the secured building or secured locker system (e.g., sleeping in the lobby, vandalizing the locker, etc.).

In some embodiments, one or more of display screens are placed within the secured building, within the secured locker system, or anywhere close to either of them to perform a display function. In some embodiments, the BOS 118 may centrally manage the display screens, including controlling the display contents on the screens. For example, Lost-and-Found items, missing pets, AMBER alerts, COVID-19 related information, and any security-related information may be displayed. Public transport information such as bus schedules and weather information may also be monitored and displayed on the display screens. In some embodiments, the display screen may be configured as a user interface, allowing navigating or searching of the general information displayed, or further allowing Internet searches. For example, a display screen may be embodied as a touchscreen I/O device 124 coupled with the EC 102.

Furthermore, any of the aforementioned functions may further initiate a series of remaining functions, including one or more of a motion detection function, a body temperature checking function, a human recognition function including face and/or voice, a display function, and a combination thereof. For example, if the motion detection function detects an unauthorized activity or activities, a human recognition function may be triggered to verify if the person is an authorized person such as a building resident, or a guest of a building resident, a delivery person, etc. If the human recognition function has previously verified that person is an authorized person (e.g., via cameras located outside the entrance) before the motion detectors capture any unauthorized activities, the BOS may not trigger subsequent security actions based on the person's unauthorized activities (e.g., even if that person lingers for a longer period of time in front of the elevator, etc.). For example, if the body temperature checking function detects abnormal body temperature, a human recognition function may be subsequently triggered to verify the identity of the person, and a display function may also be triggered. In other words, the sequence of performing the series of functions may not be limited by the embodiments herein.

Example embodiments described herein provide methods and systems for access to a secured building and access to a secured locker system. Although example embodiments are described in reference to a service provider delivering or picking up a package, a person skilled in the art may apply the methods and systems as described by example embodiments herein for access to a building or a locker system in the case of other service providers, who require access to the building or the locker system. Accordingly, delivery a package is but one example of a service provider, and thus the methods and systems described herein are not limited to such example.

Another aspect of the invention provides for a method of tracking a vehicle or a delivery person and providing route planning for delivery or pickup of a package associated with a recipient and an address of the recipient. The destination address can be, as non-limiting examples, a building, an office, a dwelling, etc. In relation to the present disclosure, the term “package” includes any type of package, which include a mail letter. After approaching the destination address, the delivery person may be allowed to access the property or building (and the locker system/room), provided that the verification procedure is successful (e.g., the outcome of the verification procedure is positive). The allowance of access may include a door to the building and/or a door to the locker system/locker room being caused to open.

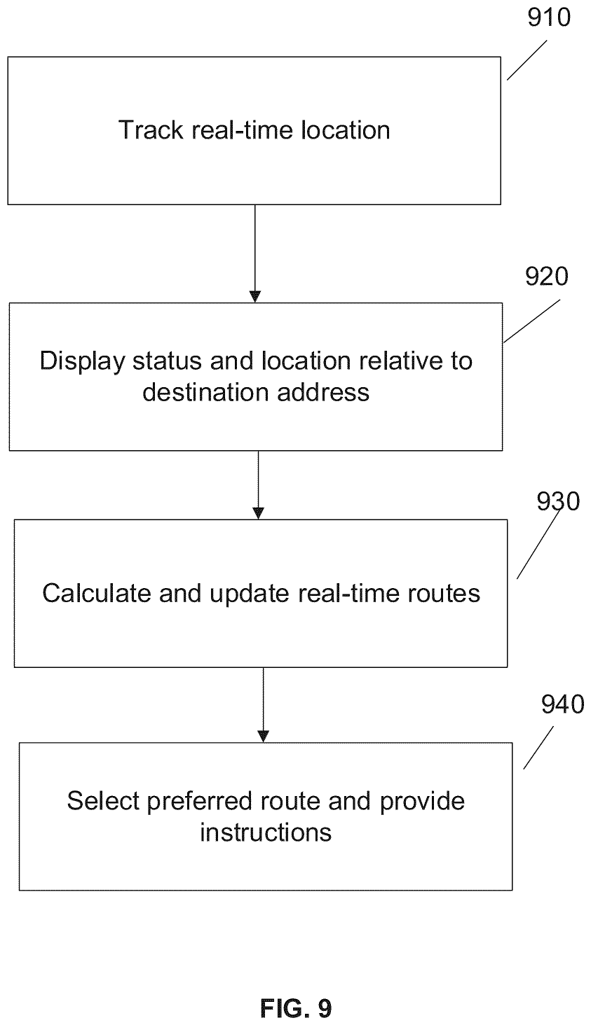

FIG. 9 illustrates a flowchart for real-time vehicle tracking and route planning, according to an embodiment of the present invention. In practice, this allows both the recipient and the carrier company/delivery personnel to view the current location of the delivery vehicle relative to the destination property, enhancing transparency and efficiency on both ends. It further provides an estimated delivery time, and one or more planned routes options (i.e., critical path planning).

In embodiments, at step 910, a location tracker can track and monitor the location of the vehicle or the delivery person in real-time. The location tracker can be associated with the vehicle or the delivery person. It can be a GPS tracker associated with the vehicle, or the delivery person's mobile device (e.g., mobile phone, fob, tablet), etc.

At step 920, the real-time location of the vehicle or the delivery person relative to the recipient's address can be displayed, and a real-time status for the delivery or the pickup of the package can be provided.

In embodiments, the status (real-time status) can include an estimated arrival time and/or an actual arrival time based on the real-time location of the vehicle or the delivery person relative to the recipient's address. In embodiments, the status further can include a delivery status indicating the package is one of: in transit, out for delivery, or waiting for pickup. For example, the status displayed can be “Package A, waiting for pickup, at SOHO building at 123 Street, City X, estimated pickup in 1 hour”, “Package B, in transit, from City X to City Y sorting station, estimated arrival in 4 hours”, “Package C, out for delivery, from City Y sorting station to 456 Drive, City Y, estimated delivery in 30 minutes”, etc. Furthermore, the status can include the distance between the starting and stopping locations.

At step 930, one or more routes are calculated or planned for the delivery or pickup of the package based on predefined metrics. The planned routes can be displayed on a mobile device or application. The predefined metrics can be managed or modified, for example, metrics can be added or removed. In embodiments, predefined metrics can include: a capacity and a productivity of the delivery person being tracked in real-time, including a duration of breaks and idle times, an average time spent on each delivery or pickup, and a training or experience level of the delivery person; a type of the vehicle utilized; one or more alternative transportation options including walking; a priority level of the package; and a priority level of the building or a priority level of an area that the building belongs to. In embodiments, the priority level of the building is based on a volume level of package deliveries and pickups.

In embodiments, the values of the predefined metrics can be updated in real-time. Accordingly, the routes are re-calculated or adjusted in accordance with the updated values of the predefined metrics, as the real-time metrics values can reflect current conditions which are important to route planning, such as traffic, weather, toll fees, parking availability, and other relevant factors.

At step 940, when a preferred route is selected, instructions are provided to the delivery person, based on the preferred route being selected. The route selection can be an automatic selection from the one or more planned routes based on a predefined criterion (e.g., fastest route, avoiding toll fees, least walking distance). The automatic selection also considers the predefined metrics values updated in real-time. For example, when the most efficient route does not work due to an accident, the algorithms of the system automatically re-calculate and instruct the delivery person to follow the second most efficient route avoiding the accident scene.

In embodiments, a delivery person will follow the planned route(s). For example, the delivery person may follow the displayed instructions to switch from driving a vehicle to walking, from walking to biking, etc., taking into account the various factors such as street parking availability and city parking bylaws, and the practicality of walking in certain conditions. In embodiments, the planned route(s) may be overridable. For example, the delivery person may find the route blocked by fallen trees due to a storm but such an accident is not updated yet as per the displayed instructions, hence the delivery person may opt to take another route or detour.

In accordance with embodiments of the present invention, all the relevant information related to a package and/or delivery person, (e.g., package's tracking information, delivery person's availability/productivity information) can be stored in one or more databases. The tracking information includes the real-time location of the vehicle or the delivery person for the delivery or the pickup of the package, the real-time location of the vehicle or the delivery person relative to the recipient's address, the real-time status for the delivery or the pickup of the package, the planned one or more routes, and the selected route.

In embodiments, the databases can be an integral part of the BOS or external entities. The database can be secured by controlling access only by authorized entities, using a secured VPN, or using a proprietary algorithm to decode hashed information.

In embodiments, the productivity or efficiency of a delivery person can be tracked by a real-time GPS tracker of the delivery person, which can be different from the vehicle GPS tracker. On top of the real-time location of the employee, their productivity is also tracked by monitoring the duration of breaks and off-time during workdays. Statistics about abnormal idle times can be assessed to improve employee productivity (e.g., the employee may need training or there may be an accident involved). Evaluating the time spent on deliveries or pickups in each building can help to gauge employee efficiency (e.g., expected vs. actual time spent for delivering or picking up a mail/package) and the data can also be used to categorize the building or area as “dense/high volume of demands” vs “sparse/low volume of demands”.

For example, the capacity of a delivery person can be 7 hours per day (time based) or 20 package delivery or pickups per day (transaction based) for a specific area, and their productivity can be an average of 30 minutes per package or transaction. In another example, the delivery person's training level can include whether they are able to handle chemical or bio-hazards packages, bulky items, fragile packages (including glass ware), etc. The training level can further include the delivery person's driving skills and records. In another example, the transportation options can include driving, walking, biking, etc.

In embodiments, the priority level of the packages determines which package will be handled first. The priority level of the building or a priority level of an area that the building belongs to (“dense/high volume of demands” vs “sparse/low volume of demands”) can determine which building or area will be serviced first. For example, a building with “sparse/low volume of demands” may experience a longer waiting time.

In practice, the delivery person/carrier company and the recipient can communicate in a one-way or two-way communication channel/method (video or audio). The communication can be in real-time. In embodiments, the property management (e.g., building security staff) may join the communication as well.

In embodiments, the communication can be enabled by an entry console or an application from a mobile device of the delivery person and the recipient. For example, a delivery person may launch a video call at the entry console (at the building entrance or in the lobby or at the locker room) to reach out to the recipient who receives the call on the recipient's phone. In another example, the delivery person may launch the call from their phone. Alternatively, the recipient can receive and answer the call at any entry console associated with the building/property. Notably, this supports efficient problem resolution in real-time at a relatively low cost.

Another aspect of the invention provides for a method for decentralized sorting of a plurality of packages using sub-stations or sub-boxes. Each of the plurality of packages is associated with an address and the address (e.g., 123 Street) belongs to a geographic area which corresponds with a station or a sub-station. In embodiments, decentralized sorting at sub-stations or sub-boxes are often applied for a larger area or areas with a dense population. In other words, a preliminary sorting (by a machine or a person) is conducted for a larger area (e.g., the whole downtown area), and all the packages or mails for the downtown area will be placed into a designated bag or container. These packages or the designated bag will be later placed at a designated sub-station. It is followed by secondary sorting (to smaller areas such as specific streets or districts areas within the downtown area). For example, another machine or person picks up the designated bag full of packages or mails at the sub-station and further sorts the packages or mails based on more detailed address/area/location. Finally, the further sorted packages are delivered to the door or building (e.g., final delivery to individual mailboxes or pigeonholes). In embodiments, sub-station sorting may not be required for a less populated area.

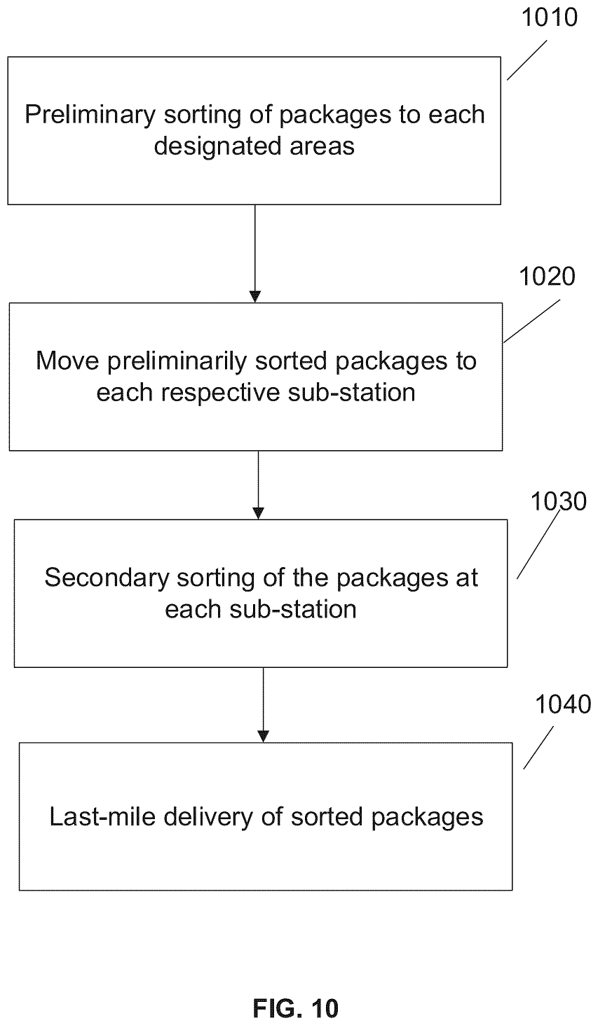

FIG. 10 illustrates a flow chart for a decentralized sorting method, according to an embodiment of the present invention.

At step 110, an initial/preliminary sorting of the plurality of packages is performed and the packages are sorted to determine if they need to be further sorted at sub-stations. Each sub-station corresponds to a designated area which requires secondary sorting of the packages. The initially sorted packages for the designated area are placed in a designated container or bag.

At step 120, the sorted packages in bags will be transported or moved to each respective sub-station. The sub-stations can be a facility located nearer to the designated areas.

At step 130, a subsequent/secondary sorting of the packages in each designated container or bag is performed.

At step 140, the further sorted packages are delivered based on the associated address (also referred to as the last-mile delivery). The address can include a street or road name and number, or a postal code. The last-mile delivery refers to delivery to a mailbox or pigeonhole.

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Other embodiments consistent with the present disclosure will be apparent from consideration of the specification and the practice of the disclosure disclosed therein. Accordingly, the specification and the embodiments disclosed therein are to be considered examples only, with a true scope of the disclosure being disclosed by the following numbered claims.

What is claimed is:

1. A real-time method of tracking a vehicle or a delivery person and providing route planning for delivery or pickup of a package associated with a recipient and an address of the recipient, the recipient's address being within a multi-tenant building or portion thereof, the method comprising:
tracking, by a location tracker, a location of the vehicle or the delivery person in real-time, wherein the location tracker is associated with the vehicle or the delivery person;
displaying the real-time location of the vehicle or the delivery person relative to the recipient's address;
providing a real-time status for the delivery or the pickup of the package, the status including an estimated arrival time and an actual arrival time based on the real-time location of the vehicle or the delivery person relative to the recipient's address, the status further including a delivery status indicating the package is one of: in transit, out for delivery, or waiting for pickup;
planning and displaying one or more routes for the delivery or the pickup of the package based on predefined metrics, wherein the predefined metrics are updated in real-time;
updating the one or more routes in real-time based on the updated predefined metrics;
providing instructions to the delivery person, based on an automatic selection from the one or more planned routes and the updated predefined metrics; and
storing tracking information in one or more databases, wherein the tracking information includes the real-time location of the vehicle or the delivery person for the delivery or the pickup of the package, the real-time location of the vehicle or the delivery person relative to the recipient's address, the real-time status for the delivery or the pickup of the package, the planned one or more routes, the selected route; and
the method further comprising:
receiving, by an entry console of the building or portion thereof, a request for entry into the building or portion thereof, wherein the request comprises a tracking code associated with the package;
forwarding, by the entry console, the tracking code to a building operating system (BOS);
performing, by the BOS, a verification procedure based on the tracking code to determine if access to the building or portion thereof is to be permitted or denied, the verification procedure comprising:
sending, by the BOS, a verification request comprising the tracking code to the one or more databases;
comparing the tracking code in the verification request to the tracking information in the one or more databases and determining if access is permitted or denied based on the comparison;
wherein the tracking information in the one or more databases confirms that a delivery or pickup location of the package is in the building or portion thereof and the delivery status of the package is out for delivery or waiting for pick-up, thereby access is permitted;
providing, by the BOS, based on outcome of the verification procedure, instructions to the entry console regarding granting access into the building or portion thereof.

2. The method of claim 1, wherein the outcome of the verification procedure is positive, and the instructions comprise instructions for the entry console to open a door into the building or portion thereof, or instructions for the entry console to provide an access code for accessing the building or portion thereof.

3. The method of claim 1, wherein the delivery or the pickup of the package is via a locker system or portion thereof in or in proximity to the building or portion thereof.

4. The method of claim 1, wherein accessing the building or portion thereof includes accessing a locker system or portion thereof.

5. The method of claim 4, wherein the outcome of the verification procedure is positive, and the instructions comprise instructions for the entry console to open a door into the locker system or portion thereof, or instructions for the entry console to provide an access code for accessing the locker system or portion thereof.

6. The method of claim 3 wherein the locker system comprises a plurality of locker/mail boxes.

7. The method of claim 1, wherein the one or more databases is updated in real-time at various stages of the deliveries.

8. The method of claim 1, wherein at least one of the one or more databases comprises a database of the building or portion thereof and a database of a carrier arranging the delivery or picking up the package.

9. The method of claim 1, wherein the tracking code is a barcode, the barcode being one of: 1 dimensional linear bar code; 2-dimensional bar code, an image, specialized augmented postal code; intelligent mail barcode; and electronic product code.

10. The method of claim 1, further comprising:
sending a message to a device associated with the recipient's address, the message indicating that access to the building or portion thereof has been granted for the delivery person.

11. The method of claim 4, further comprising:
sending a message to a device associated with the recipient's address, the message indicating that access to the locker system or portion thereof has been granted for the delivery person.

12. The method of claim 12, wherein the device is a mobile of the recipient or a mobile of a tenant associated with the recipient's address.

13. The method of claim 1 further comprising enabling a one-way or two-way video communication between the recipient and the delivery person in real-time.

14. The method of claim 1, wherein the predefined metrics include:
a capacity and a productivity of the delivery person being tracked in real-time, including a duration of breaks and idle times, an average time spent on each delivery or pickup, and a training or experience level of the delivery person;
a type of the vehicle utilized;
one or more alternative transportation options including walking;
a priority level of the package; and
a priority level of the building or a priority level of an area that the building belongs to, wherein the priority level of the building is based on a volume level of package deliveries and pickups.

15. The method of claim 1, wherein the one or more databases are secured by controlling access only by authorized entities, using a secured virtual private network (VPN), or using a proprietary algorithm to decode hashed information.

16. A method for decentralized sorting of a plurality of packages using sub-stations, each of the plurality of packages being associated with an address, the method comprising:
performing an initial sorting of the plurality of packages, each sub-station corresponding to a designated area, wherein the sorted packages for the designated area are placed in a designated bag; and
for each designated bag, performing a subsequent sorting of the packages placed within, wherein the further sorted packages are delivered based on the associated address, the address including a street or road name and number, or a postal code.

17. The method of claim 1, wherein the delivery of the package including the pickup of the package is to or from a locker system in the secured building.

18. A system for accessing a secured locker system in proximity to a building according to the method of claim 4, the system comprising an entry console in network connection with a building operating system (BOS) and one or more I/O devices.
